(19) United States
(12) Patent Application Publication
(10) Pub. No.: US 2015/0277074 A1
(43) Pub. Date: Oct. 1, 2015

(54) CABLE WITH AN EXOSKELETON

(71) Applicant: AFL Telecommunications LLC, Duncan, SC (US)

(72) Inventors: Brett VILLIGER, Simpsonville, SC (US); Joseph CIGNARALE, Greer, SC (US)

(73) Assignee: AFL Telecommunications LLC, Duncan, SC (US)

(21) Appl. No.: 14/212,698

(22) Filed: Mar. 14, 2014

Related U.S. Application Data
(60) Provisional application No. 61/794,262, filed on Mar. 15, 2013.

(51) Int. Cl. G02B 6/44

(52) U.S. Cl. CPC G02B 6/443; G02B 6/4494; G02B 6/4495

(57) ABSTRACT

A cable with a first jacket made from a plastic material and a second jacket made from a plastic material with a tensile strength greater than or equal to approximately 2,600 psi and tensile modulus greater than or equal to approximately 180,000 psi, which creates an exoskeleton for the cable.

### CROSS-REFERENCE TO RELATED APPLICATIONS

This application is based upon and claims the benefit of priority from U.S. Provisional Application No. 61/794,262, filed Mar. 15, 2013 in the United States Patent and Trademark Office, the disclosures of which are incorporated herein in its entirety by reference.

### BACKGROUND

The invention is related to cables which are contained in a jacket to provide easy installation, and more particularly, to a cable with a first jacket made from a plastic material and a second jacket made form a high modulus plastic material, which creates an exoskeleton for the cable.

### 2. RELATED ART

Microduct cables are common in the telecommunications industry. Most cables have been designed for use outdoors where microducts are installed. The use of microduct cables for indoor use is not as prevalent, but is an option when flexibility is needed or traditional cable may be difficult to install. Installing cables indoors can be more difficult with regards to space, equipment, and cable design.

Conventional microduct cables include optical fibers which are capable of transmitting voice, video, and data information. A fiber optic cable should have a craft-friendly construction which permits ease of installation. Installation of a fiber optic cable typically requires the pulling of the cable through a cable passageway. The cable passageway can be, for example, a duct, a tube, a cable enclosure, building structural features, a trough, a tunnel, a tray, a trunk, a manhole, a handhole, a fingerhole, or a splice box.

Installing air blown cable requires injection equipment, air supply, etc. which can all be cumbersome in cramp locations. The microduct system (cable and duct) must meet fire safety requirements depending on the location of the installation. Today's systems are fire safety tested as a system (cable and duct) limiting the cable and duct options when flexibility is needed, i.e. a non-listed cable must be fire safety tested in every duct type that it may be blown into.

The ease with which a fiber optic cable is installed in a cable passageway may be dependent on certain characteristics of the fiber optic cable. For example, surface area contact between the cable jacket, which is typically of the circular profile type, and surface areas in the cable passage way causes frictional resistance to the cable pulling force. Resistance to the cable pulling force can be a limiting factor regarding the length or ease of the cable to be pulled. Such resistance may also be a function of the coefficient of friction of the cable jacketing material.

Additionally, a light-weight cable is generally easier to pull than a heavy cable. Cable flexibility is a factor as the use of stiff cable components makes the cable difficult to bend during the cable pulling operation. Cable size is also a factor as a cable with a small cross sectional area is generally easier to pull through a narrow passageway than a cable with a large cross sectional area. Moreover, apart from ease of installation, the cost per unit length of the cable may be an important factor in deciding between commercially available fiber optic cables.

Installers and customers installing cable for indoor use prefer cables that are clean and easy to install (fiber cabinets, connectors, etc.). Most cables offered for indoor microducts are messy, difficult to open up, and require considerable amount of care when putting into a splice box and connectorizing fibers.

Taking the foregoing factors into consideration, fiber optic cable designs having circular profile jackets are part of the background of the present invention. For example, a fiber optic cable which may be difficult to route through a passageway is disclosed in U.S. Pat. No. 5,029,974. The cable includes two steel strength members embedded in a circular profile cable jacket. The steel strength members are designed to resist axial compression due to, for example, aging shrinkage or thermal contraction of the cable jacket. The use of steel strength members creates a spark hazard and their weight may negatively affect the cable pulling operation. Additionally, the circular profile jacket can present a substantial degree of surface area contact and friction with the cable passageway that can result in substantial resistance to a cable pulling force.

Additionally, fiber optic cable designs having noncircular profile jackets may be difficult to install in cable passageways. For example, a cable disclosed in U.S. Pat. No. 4,844,575 is a composite cable type and includes an oval profile cable jacket. The oval profile can present a substantial amount of surface area contact with the cable passageway, and the weight of the cable can make it difficult to install in a cable passageway.

In addition, fiber optic cable designs having a cellularized cable component including at least one optical fiber and a non-removable cable jacket can make it difficult to provide access to a subunit. For example, the cable disclosed in U.S. Pat. No. 6,160,940 is a composite cable type and includes a non-removable cable jacket.

The present inventive concept is not limited to fiber optic or microduct cables. It is an object of the present inventive concept to provide a cable that is easy to install in a cable passageway which has a removable exoskeleton to provide access to the subunit which is an interconnect style cable. The exoskeleton is made of a thin semi-rigid material so that it provides stiffness and rigidity without adding bulk.

It is another object of the present invention to provide a cable with a removable exoskeleton that is light weight and presents minimal resistance to a cable pulling force during installation.

### SUMMARY

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

An embodiment of the invention is a cable with a first jacket made from a plastic material, and a second jacket made from a plastic material with a tensile strength greater than or equal to approximately 2,600 psi and tensile modulus greater than or equal to approximately 180,000 psi, which creates an exoskeleton for the cable.

Another feature of the invention includes the first jacket being made of a material including of at least one of polyvinyl chloride, polyvinylidene fluoride, polyethylene, low smoke zero halogen, polybutylene terephthalate, thermoplastic polyester elastomer and polypropylene.

Another feature of the invention includes second jacket being made of a material including of at least one of polyvinyl chloride, polyvinylidene fluoride, polyethylene, low smoke zero halogen, polybutylene terephthalate, thermoplastic polyester elastomers, polypropylene.

Another feature of the invention includes the secondary jacket having a shape that is at least one of a circular shape, a star shape, a gear shape, and a multi-arch shape.

Another feature of the invention includes the cable further including strength elements.

Another feature of the invention includes the cable further including water swellable elements.

Another feature of the invention includes the cable further including an optical fiber.

Another feature of the invention includes the cable in which the secondary jacket does not adhere to the first jacket and is removable.

### BRIEF DESCRIPTION OF THE DRAWING

FIG. 1 is a cross-sectional view of an embodiment of a cable according to the present invention.

FIG. 2 is a cross-sectional view of an embodiment of a secondary jacket with a circular shape.

FIG. 3 is a cross-sectional view an embodiment of a secondary jacket with a star shape.

FIG. 4 is a cross-sectional view of an embodiment a secondary jacket with a multi-arch shape.

FIG. 5 is a cross-sectional view of an embodiment a secondary jacket with a gear shape.

### DETAILED DESCRIPTION

The following detailed description is provided to gain a comprehensive understanding of the apparatuses described herein. Various changes, modifications, and equivalents of the apparatuses described herein will suggest themselves to those of ordinary skill in the art. Descriptions of well-known functions and structures are omitted to enhance clarity and conciseness.

Hereinafter, an exemplary embodiment will be described with reference to accompanying drawings.

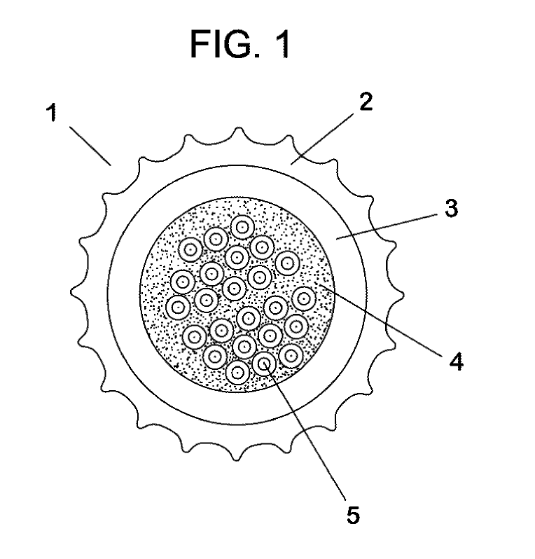

Referring to the drawings, FIG. 1 is a cross-sectional view of a cable 1 according to an exemplary embodiment of the invention. The cable 1 includes secondary jacket 2 surrounding a primary jacket 3. Inside the primary jacket 3 are strength elements and water swellable elements 4. A plurality of loose fibers 4 is bundled within the cable 1, although the cable could contain wires or a combination of wires and fibers.

The primary jacket 3 can be made of any type of plastic material. For example, any variation of material from the group consisting of: polyvinyl chloride (PVC), polyvinylidene fluoride (PVDF), polyethylene (PE), low smoke zero halogen (LSZH), polybutylene terephthalate (PBT), thermoplastic polyester elastomers, polypropylene (PP), etc. Table 1 shows properties of a type of PVC material that may be used in the primary jacket 3.

TABLE 1
A 75° C. RATED, HIGHLY FLAME RETARDED,
LEAD FREE, LOW SMOKE JACKETING COMPOUND
FOR DEMANDING PLENUM CABLE CONSTRUCTIONS.

| Properties | Results | Tolerance | Test Method |
|---|---|---|---|
| Specific Gravity | 1.69 | +/−0.02 | ASTM D 792 |
| Durometer D, Instantaneous | 71 | +/−3 | ASTM D 2240 |
| Durometer D, 15 Second | 58 | +/−3 | ASTM D 2240 |
| Tensile Strength, psi (15 mil) | 2500 | — | ASTM D 412 |
| Tensile Strength, psi (75 mil) | 2100 | — | ASTM D 412 |
| Elongation, % (15 mil) | 190 | — | ASTM D 412 |
| Elongation, % (75 mil) | 210 | — | ASTM D 412 |
| Brittle Point, ° C. (F-50) | −4 | — | ASTM D 746 |
| Oxygen Index, % (125 mil) | 60 | — | ASTM D 2863 |
| Dielectric Constant, 100 MHz | 3.53 | — | ASTM D 150 |
| @ 23 C. | | | |
| Dissipation Factor, 100 MHz | 0.0180 | — | ASTM D 150 |
| @ 23 C. | | | |
| Air Oven Aged 10 Days | | — | — |
| @ 100 C. (15 mil) | | | |
| Retention of Tensile | 108 | — | UL Standard |
| Strength, % | | | |
| Retention of Elongation, % | 87 | — | UL Standard |

The secondary jacket 2 may be made of any type of higher modulus material. In the context of this invention, a higher modulus material means a material that has a tensile strength greater than or equal to approximately 2,600 psi and a tensile modulus greater than or equal to approximately 180,000 psi. In an exemplary embodiment, any variation of material selected from the group consisting of: PVC, PVDF, PE, LSZH, PBT, thermoplastic polyester elastomers, PP, etc. Tables 2 and 3 are exemplary embodiments of properties of the materials that may be used in the secondary jacket 2.

TABLE 2

| | TYPICAL | |
|---|---|---|
| | PROPERTIES | ASTM |
| Hardness (Shore ‘D’ Duro +/−3) | 82 | D-2240 |
| 10 Second Reading | | |
| Specific Gravity (+/−0.02) | 1.44 | D-792 |
| Tensile Strength, psi | 6,300 | D-638 |
| Elongation @ Break, % | 90 | D-638 |
| Flexural Modulus, psi | 400,000 | D-790 |
| 0.05 in/min | | |
| Tensile Modulus, psi | 415,000 | D-638 |
| 0.2 in/min | | |
| Izod Impact Strength, ft-lb/in. | 2.89 | D-256 |
| 73° F. 0.125″ thickness | | |
| Compression Molded | | |
| Drop Dart Impact Resistance | 2.30 | D-4226 |
| 73° F. ½″ Tup Procedure A | | |
| Cone Calorimeter @ 75 kW/m² | | |
| Heat Release Rate, Peak (kW/m²) | 115.63 | |
| Heat Release Rate, Average, (kW/m2) | 86.58 | |
| Total Heat Evolved (MJ/m²) | 68.70 | |
| Effective Heat of Combustion, Avg (MJ/kg) | 9.54 | |
| Specific Extinction Area, (m²/kg) | 448.41 | |
| Extinction Coeff, 1^{st} Peak (1/m) | 2.3 | |

TABLE 3

| Properties | Results | Tolerance | Test Method |
|---|---|---|---|
| Specific Gravity | 1.66 | +/−0.03 | ASTM D 792 |
| Durometer D, Instantaneous | 78 | +/−3 | ASTM D 2240 |
| Durometer D, 15 Second | 71 | +/−3 | ASTM D 2240 |
| Tensile Strength, psi | 2900 | — | ASTM D 412 |
| (75 mil) | | | |
| Elongation, % (75 mil) | 140 | — | ASTM D 412 |
| Oxygen Index, % (125 mil) | 54 | — | ASTM D 2863 |
| Flexural Modulus, psi | 180,000 | — | ASTM D 790 |
| (75 mil) | | | |

The secondary jacket 2 improves the performance of the cable with respect to installation and handling. The secondary jacket 2 is a higher modulus material that creates a semi-hard shell or exoskeleton for the cable 1. The secondary jacket 2 makes the cable 1 stiffer, allowing the cable 1 to be pushed considerable distances without using air assist and without adding bulk to the cable. In an exemplary embodiment, material used for the exoskeleton is a semi-rigid PVC material.

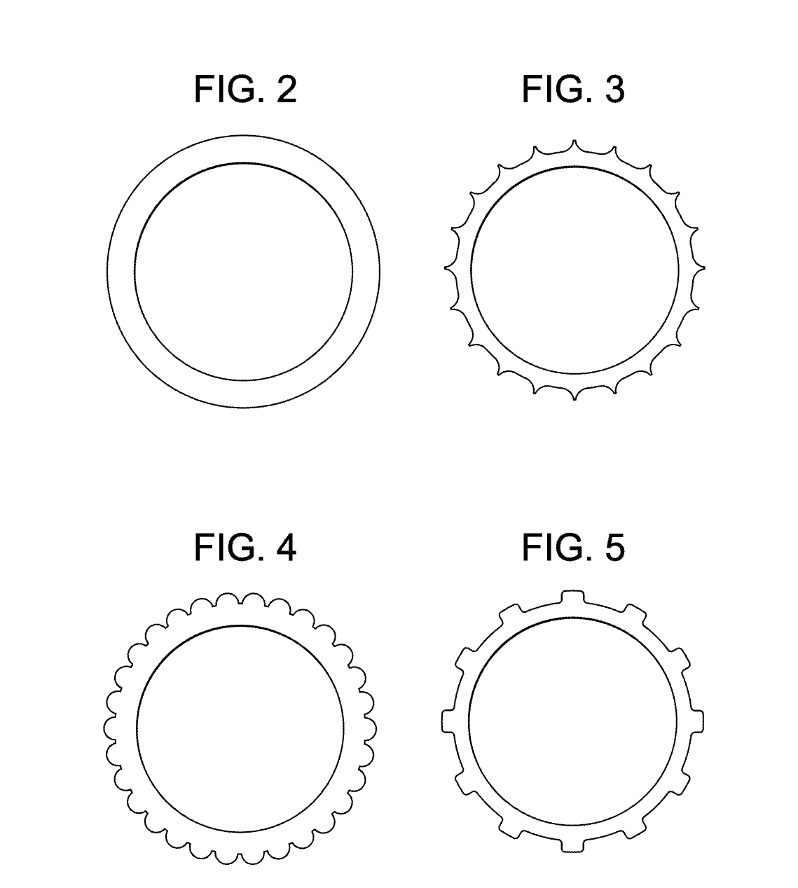

This is a benefit when air supply can be difficult and can save installation costs and time. The jacket shape and finish improves the coefficient of friction allowing for longer installations. The shape of the secondary jacket minimizes surface contact while maximizing airflow surface area. The shape of the secondary jacket can vary in order to minimize contact area between the jacket and the duct that the cable is being injected into. In an exemplary embodiment, the shape of the secondary jacket can be but not limited to: a circular shape, a star shape, a gear shape, a multi-arch shape, or any variation thereof. See FIGS. 2-5 for exemplary shapes.

In one embodiment, the secondary jacket 2 does not adhere to the cable, and the secondary jacket 2 can be easily removable to provide access to the subunit which is an interconnect style cable, using known stripping tools.

In another embodiment, the secondary jacket 2 adheres to the cable.

The cable design has a interconnect style cable under the secondary jacket that allows for quick and safe installation within standard fiber enclosures.

The cable described in an exemplary embodiment consists of a bare fiber simplex/interconnect type design that is jacketed in a secondary jacket that facilitates installation.

In one exemplary embodiment, the cable design is independently fire safety listed. This allows the cable to be installed in any microduct (fire safety listed or not). The plastic materials used to construct the cable jackets can be compounded with a flame retardant package that allows the materials to be used in areas that require certain flame ratings. Amounts and types of flame retardants can be varied to create varying degrees of flame retardancy. The industry typically specifies these degrees of flame retardancy in groups (LSZH, General Purpose, Riser, Plenum, IEC). Each group has different standards for testing. In an exemplary embodiment, the cable meets testing to UL 1666 (Riser Rating) which is “Test for Flame Propagation Height of Electrical and Optical-Fiber Cables Installed Vertically in Shafts.”

Persons of ordinary skill in the art will appreciate that the foregoing embodiments of the present invention are intended to be illustrative of the inventive concepts rather than limiting. Moreover, persons of skill in the art will understand that variations can be made to the present invention without departing from the scope of the appended claims. For example, although the exoskeleton of the secondary jacket have been described with reference to FIG. 1, the skilled artisan will appreciate that other surface irregularities can be used that will exhibit a suitably low resistance to a cable pulling force, for example: an apex of any of the crests or hollows may be more sharply defined to roughly come to a rounded-off point, can be more rounded than shown in the drawing figures, or can be truncated with flat zones. In addition, the surface irregularities can include, e.g., dimple-like indentations, a saw-tooth configuration, ripples, teat-like extensions, lines, grooves, etc. In addition, profiles may be modified to include step-like or additional sinusoidal shapes modifying the basic sinusoidal profile.

The profiles of cable jackets made according to the present invention, although shown as having a center coincident with the center of the cable, can be eccentric with respect to the center of the cable. The profiles in an exemplary embodiment of the present invention can roughly approximate a sinusoidal wave, or they can approximate a sinusoidal function with mathematical precision within a nominal range. In addition, rather than being symmetrical, in another exemplary embodiment, profiles can include an asymmetrical configuration. Although the embodiments presented hereinabove discuss components of the slotted core type, skilled artisans will appreciate that cable jackets can be applied over other types of fiber optic cable components which require cable jackets, for example, components of the core tube, buffer tube, fiber bundle, or optical ribbon types having a parallel, helical, or SZ feature. Fiber optic cables made in accordance with the present invention can be used with a standard pulling attachment.

As mentioned above, although the exemplary embodiments described above are various cables for microducts, they are merely exemplary and the general inventive concept should not be limited thereto, and it could also apply to other types of cables.

What is claimed:

1. A cable, comprising:
a first jacket made from a plastic material; and
a second jacket made from a plastic material with a tensile strength greater than or equal to approximately 2,600 psi and tensile modulus greater than or equal to approximately 180,000 psi, which creates an exoskeleton for the cable.

2. The cable of claim 1, wherein the first jacket is made of a material including of at least one of polyvinyl chloride, polyvinylidene fluoride, polyethylene, low smoke zero halogen, polybutylene terephthalate, thermoplastic polyester elastomer and polypropylene.

3. The cable of claim 1, wherein the second jacket is made of a material including of at least one of polyvinyl chloride, polyvinylidene fluoride, polyethylene, low smoke zero halogen, polybutylene terephthalate, thermoplastic polyester elastomers, polypropylene.

4. The cable of claim 2, wherein the second jacket is made of a material including of at least one of polyvinyl chloride, polyvinylidene fluoride, polyethylene, low smoke zero halogen, polybutylene terephthalate, thermoplastic polyester elastomers, polypropylene.

5. The cable of claim 1, wherein the secondary jacket has a shape that is at least one of a circular shape, a star shape, a gear shape, and a multi-arch shape.

6. The cable of claim 2, wherein the secondary jacket has a shape that is at least one of a circular shape, a star shape, a gear shape, and a multi-arch shape.

7. The cable of claim 3, wherein the secondary jacket has a shape that is at least one of a circular shape, a star shape, a gear shape, and a multi-arch shape.

8. The cable of claim 1, further comprising strength elements.

9. The cable of claim 1, further comprising water swellable elements.

10. The cable of claim 1, further comprising an optical fiber.

11. The cable of claim 1, wherein the secondary jacket does not adhere to the first jacket and is removable.

12. The cable of claim 4, further comprising strength elements.

13. The cable of claim 4, further comprising water swellable elements.

14. The cable of claim 4, further comprising an optical fiber.

15. The cable of claim 4, wherein the secondary jacket does not adhere to the first jacket and is removable.

16. The cable of claim 7, further comprising strength elements.

17. The cable of claim 7, further comprising water swellable elements.

18. The cable of claim 7, further comprising an optical fiber.

19. The cable of claim 7, wherein the secondary jacket does not adhere to the first jacket and is removable.
